(19) United States
(12) Patent Application Publication
(10) Pub. No.: US 2020/0014230 A1
(43) Pub. Date: Jan. 9, 2020

(54) BATTERY DISCHARGE CONTROL METHOD, BATTERY DISCHARGE CONTROL SYSTEM, AND SMART BATTERY

(71) Applicant: SZ DJI TECHNOLOGY CO., LTD., Shenzhen (CN)

(72) Inventor: Caihui ZHANG, Shenzhen (CN)

(21) Appl. No.: 16/576,092

(22) Filed: Sep. 19, 2019

Related U.S. Application Data
(63) Continuation of application No. PCT/CN2017/079137, filed on Mar. 31, 2017.

(51) Int. Cl. H02J 7/00; H01M 10/44; H01M 10/42

(52) U.S. Cl. CPC H02J 7/0063; H01M 10/443; H01M 2010/4271; H02J 2007/0067; H02J 2007/0098; H01M 10/4257

(57) ABSTRACT

A battery discharge control method is provided. The battery discharge control method includes detecting a temperature of a battery when the battery self-discharges. The battery discharge control method also includes adjusting a discharge speed for the self-discharge of the battery based on the temperature of the battery.

### CROSS-REFERENCE TO RELATED APPLICATIONS

This application is a continuation application of International Application No. PCT/CN2017/079137, filed on Mar. 31, 2017, the entire content of which is incorporated herein by reference.

### TECHNICAL FIELD

The present disclosure relates to the technology field of battery and, more particularly, to a battery discharge control method, a battery discharge control system, and a smart battery.

### BACKGROUND

With the continuous advancement of technologies, applications of various movable devices have increased. It has become more and more important for the performance of the battery, which is a power source of the movable devices.

Currently, due to the small memory effect and high energy advantages, lithium-ion batteries have been widely used as the power source of movable devices. When stored for long term, the lithium-ion batteries may have the battery swollen phenomenon when stored with full charge, thereby causing safety risk. Therefore, a self-discharge electric circuit or a self-discharge device may be provided to the battery, such tha the charge of the battery reduces to about 60% when stored for long term. The self-discharge electric circuit may add a discharge load to the battery to consume the charge of the battery, such that the battery ultimately reaches a desired charge.

However, to achieve the discharge effect, when the battery performs self-discharge, it has to satisfy a predetermined self-discharge speed, which may generate a large amount of heat. In addition, when multiple batteries are stacked together, due to poor heat dissipation, a relatively large amount of heat may be accumulated. As such, the temperature of the battery may be increased when stored, which may cause safety issues.

### SUMMARY

According to an aspect of the present disclosure, there is provided a battery discharge control method. The battery discharge control method includes detecting a temperature of a battery when the battery self-discharges. The battery discharge control method also includes adjusting a discharge speed for the self-discharge of the battery based on the temperature of the battery.

According to another aspect of the present disclosure, there is provided a smart battery. The smart battery includes one or multiple energy storage units configured to store electric energy. The smart battery also includes a battery discharge control system electrically connected with the one or multiple energy storage units and configured to control a discharge speed of the one or multiple energy storage units. The battery discharge control system includes a temperature sensing unit configured to detect a temperature of the one or multiple energy storage units. The battery discharge control system also includes a control unit electrically connected with the temperature sensing unit. The control unit is also configured to electrically connect with a discharge loop of the one or multiple energy storage units, and is further configured to adjust the discharge speed for a self-discharge of the one or multiple energy storage units based on the temperature of the one or multiple energy storage units detected by the temperature sensing unit. The discharge loop of the one or multiple energy storage units includes the smart battery and a discharge load serially connected between a positive terminal of the one or multiple energy storage units and a negative terminal of the one or multiple energy storage units.

According to the battery discharge control method, the battery discharge control system, and the smart battery of the present disclosure, the battery discharge control method may include detecting a temperature of the battery when the battery self-discharges; and adjusting a discharge speed when the battery self-discharges based on the temperature of the battery. As such, the discharge speed when the battery performs self-discharge may be adjusted based on the temperature of the battery, avoiding the potential to cause safety risk due to overheat during the self-discharge of the battery, and increasing the efficiency of self-discharge of the battery.

### BRIEF DESCRIPTION OF THE DRAWINGS

To better describe the technical solutions of the various embodiments of the present disclosure or the existing technology, the accompanying drawings needed to describe the embodiments or the existing technology will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a flow chart illustrating a battery discharge control method, according to an example embodiment.

FIG. 2 is a schematic diagram of a structure of a battery discharge control system, according to an example embodiment.

FIG. 3 is a schematic diagram of a structure of a temperature sensing unit included in the battery discharge control system, according to an example embodiment.

FIG. 4 is a schematic diagram of another battery discharge control system, according to an example embodiment.

FIG. 5 is a schematic diagram of a structure of a smart battery, according to an example embodiment.

### DESCRIPTIONS OF LABELS OF ACCOMPANYING DRAWINGS

1—temperature sensing unit; 2—control unit; 3—battery; 4—discharge load; 11—temperature sensing module; 12—PWM module; 21—transistor; 22—MOS; 100—battery discharge control system; 101—energy storage unit; 200—smart battery; b—base terminal; c—collector terminal; e—emitter terminal; D—drain terminal; G—gate terminal; S—source terminal.

Details of the disclosed technical solution will be explained below with reference to the accompanying drawings.

### DETAILED DESCRIPTION OF THE EMBODIMENTS

To make the objective of the present disclosure, the technical solution, and the advantages clearer, technical solutions of the embodiments of the present disclosure will be described in a clear and complete manner with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationships.

A person having ordinary skill in the art can appreciate that when the term “and/or” is used, the term describes a relationship between related items. The term “A and/or B” means three relationships may exist between the related items. For example, A and/or B can mean A only, A and B, and B only. The symbol “I” means “or” between the related items separated by the symbol. The phrase “at least one of A, B, or C” encompasses all combinations of A, B, and C, such as A only, B only, C only, A and B, B and C, A and C, and A, B, and C. The term “and/or” may be interpreted as “at least one of.”

The terms “comprise,” “comprising,” “include,” and the like specify the presence of stated features, steps, operations, elements, and/or components but do not preclude the presence or addition of one or more other features, steps, operations, elements, components, and/or groups. The term “communicatively couple(d)” or “communicatively connect(ed)” indicates that related items are coupled or connected through a communication channel, such as a wired or wireless communication channel. The term “unit,” “sub-unit,” or “module” may encompass a hardware component, a software component, or a combination thereof. For example, a “unit,” “sub-unit,” or “module” may include a housing, a device, a sensor, a processor, an algorithm, a circuit, an electrical or mechanical connector, etc.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

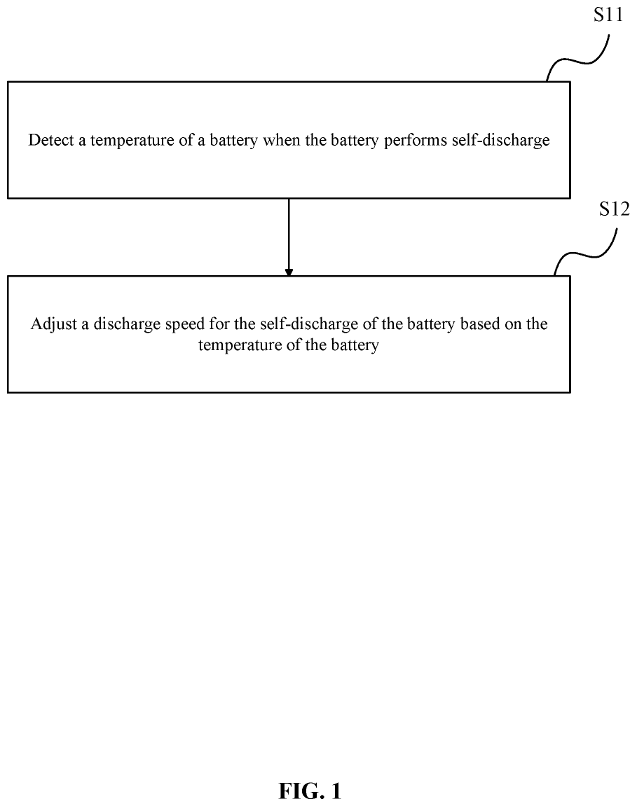

FIG. 1 is a flow chart illustrating a battery discharge control method according to an embodiment of the present disclosure. As shown in FIG. 1, the battery discharge control method of the present disclosure may include the following steps:

S11: detecting a temperature of the battery when the battery performs self-discharge.

Specifically, batteries that perform self-discharge are typically lithium-ion batteries, and may be primarily used in movable devices that require a high energy density, such as unmanned aerial vehicles (“UAVs”) or unmanned ground vehicles. Due to its own characteristics of the lithium-ion batteries, the batteries may need be stored for a long term, or may need to perform self-discharge under other conditions, to release the charge stored therein. When the battery performs self-discharge, typically, a discharge load is added to the battery to consume the electrical energy of the battery through the discharge load. Because during the self-discharge process, while electrical energy is consumed, the battery may generate heat. If the battery heat dissipation is poor due to the batteries being stacked together, etc., heat may accumulate inside the battery to cause danger. Therefore, in the self-discharge process, real-time temperature of the battery may need to be detected. All types of contacting or non-contacting temperature sensors may be used for the temperature detection of the battery. For example, a heat-sensitive resistor may be attached to the surface of the electric core of the battery to detect the temperature.

S12: adjusting a discharge speed for the self-discharge of the battery based on the temperature of the battery.

After obtaining the real-time temperature of the battery, the discharge speed for the self-discharge of the battery may be adjusted based on the real-time temperature of the battery. Specifically, when the discharge speed of the battery is relatively fast, due to power consumption reasons, heat generated by the battery is relatively large. At this moment, the temperature of the battery is relatively high. As such, the discharge speed for the self-discharge of the battery may be adjusted based on the real-time temperature of the battery. If the temperature of the battery is too high, the discharge speed of the self-discharge of the battery may be decreased to reduce the heat generated when the battery self-discharges, thereby allowing the heat accumulated in the battery to be dissipated in time through heat dissipation manners, and reducing the temperature of the battery. When the temperature of the battery is relatively low, the discharge speed for the self-discharge of the battery may be increased, to increase the self-discharge efficiency of the battery, thereby saving self-discharge time.

Specifically, when the battery self-discharges, typically, the temperature needs to be maintained within a constant temperature range, such that the battery can only not avoid the safety risk caused by the temperature being too high, but also ensure a predetermined discharge time. For example, when adjusting the discharge speed for the self-discharge of the battery based on the temperature of the battery, detailed steps may include:

Adjusting the discharge speed of the battery based on a relationship between the temperature of the battery and a predetermined battery.

Because in the process of self-discharge of the battery, when the discharge speed is constant, the heat generation of the battery and the heat dissipation speed typically can reach an equilibrium. As such, the temperature of the battery during discharge is typically maintained at a constant equilibrium value or within an equilibrium range. When the temperature of the battery is lower than or higher than the equilibrium temperature, the temperature may be adjusted and maintained adjacent the equilibrium temperature through adjusting the discharge speed of the battery. Specifically, through pre-setting a predetermined temperature, and through adjusting the discharge speed of the battery, the temperature of the battery may be stabilized adjacent the predetermined temperature, thereby ensuring suitable performance and safety of the battery.

Generally, the predetermined temperature is a safe operation temperature of the battery. When operating under this predetermined temperature, the battery would not have safety risk or seriously degrade its performance due to temperature being too high or too low.

For the convenience of adjustment, the predetermined temperature is typically a range. For example, the predetermined temperature may be 35° C. to 60° C. Within this predetermined temperature range, the battery can operate normally.

Specifically, when adjusting the discharge speed based on the relationship between the temperature of the battery and the predetermined temperature, detailed steps may include, when the temperature of the battery is greater than or equal to the predetermined temperature, decreasing the discharge speed; or when the temperature of the battery is smaller than the predetermined temperature, increasing the discharge speed.

In some embodiments, when adjusting, if the temperature of the battery is lower than the predetermined temperature, the discharge speed of the battery may be increased to increase the heat generated by the battery, thereby causing the temperature of the battery to increase; if the temperature of the battery is higher than the predetermined temperature, the discharge speed of the battery may be decreased, thereby reducing the heat generated by the battery to cause the temperature of the battery to decrease.

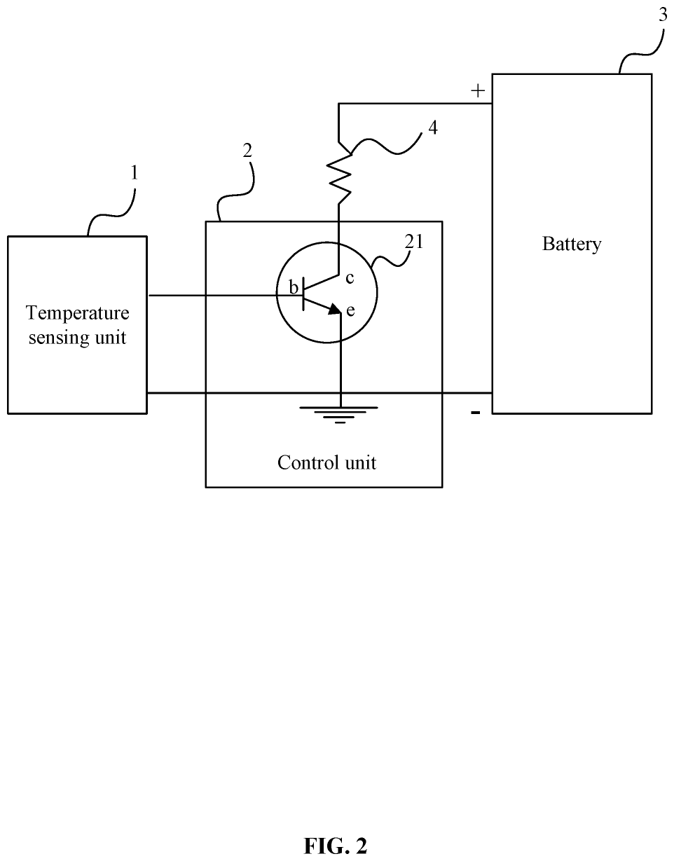

Specifically, the discharge speed for the self-discharge of the battery may be adjusted through multiple methods. For example, the speed of consuming the charge of the battery may be increased or decreased through the electric current, voltage, and power of the battery. FIG. 2 is a flow chart illustrating another battery discharge control method according to an embodiment of the present disclosure. As shown in FIG. 2, as an optional embodiment, after detecting the temperature during the self-discharge of the battery, when adjusting the discharge speed for the self-discharge of the battery based on the temperature of the battery, detailed steps may include: changing the discharge current flowing through the discharge load or the power-on time of the discharge current. In some embodiments, the discharge load and the battery may be electrically connected to form a loop.

Specifically, the discharge load may be electrically connected with the battery, thereby forming a discharge loop configured for self-discharge of the battery. The battery consumes its own charge through the voltage applied to the two ends of the discharge load and through the current. The discharge load is typically a resistive load. Thus, the power consumption by the discharge load may be adjusted by changing only the discharge current flowing through the discharge load, thereby changing the speed of consuming the charge of the battery. Specifically, when the parameters such as the resistance of the discharge load is constant, the power consumption of the discharge load is related to the amplitude of the discharge current and power-on time in a unit period. The larger the discharge current, or the longer the power-on time of the discharge current, the more the charge consumed by the discharge load, causing the discharge speed of the battery to be relatively fast; the smaller the discharge current, or when the discharge current cannot be continuously provided, but is intermittently provided, then the charge consumed by the discharge load is relatively small. At this moment, the discharge speed of the battery is relatively slow.

In some embodiments, during the step of changing the amplitude of the discharge current flowing through the discharge load or when changing the power-on time of the discharge current, in order to adjust the discharge speed of the battery, when the power-on time of the discharge current is changed, the detailed steps may include: changing the power-on time of the discharge current through a Pulse Width Modulation (“PWM”). The PWM may affect the connected/disconnected state of a switch circuit and change the power-on time of the current flowing through the discharge load through adjusting a pulse interval parameter of the signal, such as a duty cycle, etc., such that the discharge current flows through the discharge load only when the switch circuit is connected, and the charge of the battery is consumed. When the switch circuit is disconnected, the discharge load and the battery are disconnected, and the discharge cannot be performed. Specifically, when changing the power-on time of the discharge current through the PWM, typically in each period, there is one or more pulse signals. The switch circuit is connected when a pulse signal passes through, and is disconnected when no pulse signal passes through. As such, by changing the number of pulse signals in a single period and the continuous time of the pulse signals, the effective amplitude of the discharge current may be controlled to adjust the discharge speed of the battery.

When controlling the discharge time of the battery through controlling the amplitude of the discharge current, the detailed steps may include:

By adjusting the amplitude of an input current of an amplification circuit, the amplitude of the discharge current that is an output current of the amplification circuit may be changed. An input end of the amplification circuit may be a control end. A loop formed by the discharge load and the battery may be located at the output end of the amplification circuit.

Specifically, the amplification circuit typically includes an input end and an output end. A predetermined amplification ratio exists for the current or voltage between the input end and the output end. Therefore, by adjusting the voltage or current at the input end or the output end of the amplification circuit, the amplitude of the voltage or current at the other end may be changed. Because the current at the input end of the amplification circuit is typically smaller than the current at the output end, the input end of the amplification circuit may be used as a control end for control. A relatively small current may be input at the input end to control the relatively large discharge current in the loop formed by the discharge load and the battery that is located at the output end of the amplification circuit. As such, when the current at the control end changes based on the temperature of the battery, the amplitude of the discharge current may also change, and the discharge speed of the battery may be affected.

As an optional embodiment, when the amplification circuit is a transistor amplification circuit, the step of changing the amplitude of the discharge current that is the output current of the amplification circuit by adjusting the amplitude of the input current in the amplification circuit may include: changing the amplitude of the discharge current that is a current at the collector terminal by adjusting the amplitude of a current at the base terminal.

The transistor may include a base terminal, a collector terminal, and an emitter terminal. When a current flows through the base terminal, the amplitude of the current at the collector terminal of the transistor may have a predetermined ratio with respect to the amplitude of the current at the base terminal. As such, when the amplitude of the current at the base terminal of the transistor changes, the amplitude of the current at the collector terminal of the transistor also changes according to the predetermined ratio. Therefore, if the amplitude of the current at the base terminal changes with the temperature of the battery, the amplitude of the discharge current that is the current at the collector terminal may also be changed, thereby changing the power consumption of the discharge load. The discharge speed of the battery also changes accordingly. Specifically, a temperature sensing component such as a heat-sensitive resistor, etc., may be connected with the base terminal of the transistor. When the voltage at the input end of the amplification circuit of the transistor is constant, if the resistance of the heat-sensitive resistor changes as the temperature of the battery increases, the corresponding current at the base terminal may also change, which controls the current at the output end of the amplification circuit of the transistor to change.

In addition, as another optional embodiment, when the amplification circuit is a metal-oxide-semiconductor field effect transistor (or “MOS”) amplification circuit, the step of changing the amplitude of the discharge current that is the output current of the amplification circuit by adjusting the amplitude of the input current of the amplification circuit may include: changing the amplitude of the discharge current at the drain terminal of the MOS by adjusting the amplitude of the voltage at the gate terminal of the MOS.

Specifically, the MOS, i.e., the metal-oxide-semiconductor field effect transistor, may convert the change in the input voltage into change in the output current, thereby achieving amplifying the current and controlling the connect/disconnect state of the circuit. A predetermined gain may exist between the input voltage and the output current. That is, a relatively small change in the input voltage may generate a relatively large change in the output current, thereby achieving the amplification effect. The gate terminal of the MOS is typically used as the input end, and may be connected with an input voltage. The drain terminal may generate an output current. When the input voltage changes, the amplitude of the output current at the drain terminal may change, and may be used for controlling the discharge speed of the battery. The detailed control method is similar to the control based on the transistor amplification circuit, which is not repeated.

In addition, adjusting the discharge speed for the self-discharge of the battery may include: adjusting the discharge speed by adjusting a discharge parameter of the discharge load. Because the discharge load may include various structures and components, a discharge load having an adjustable parameter may be disposed. The discharge speed may be adjusted by adjusting the discharge parameter of discharge load.

Optionally, the discharge parameter of the discharge load may include at least one of: a discharge time, a discharge frequency, a configuration of the discharge circuit, a resistance of the discharge resistor. The discharge time is a time in which the two ends of the discharge load are connected with the battery such that a discharge voltage is applied or a discharge current flows therethrough. Therefore, the discharge time of the discharge load may be changed based on the temperature of the battery, thereby adjusting the discharge speed of the battery. When the discharge load is a load having a discharge frequency, such as a capacitor and an inductor, the discharge speed of the battery may be adjusted by adjusting the discharge frequency of the discharge load based on the temperature change of the battery; or a discharge circuit having variable components may be configured. Under different temperatures, the discharge speed may be adjusted by changing the configuration of the discharge circuit. The discharge load may be a resistive load. The resistance of the discharge load may be adjusted by a control unit based on the detected change of the temperature of the battery, thereby changing the discharge speed of the battery.

In some embodiments, the battery discharge control method may include: detecting a temperature of the battery when the battery self-discharges; adjusting a discharge speed for the self-discharge of the battery based on the temperature of the battery. As such, the discharge speed at which the battery self-discharges may be adjusted based on the temperature of the battery, avoiding the safety risk caused by the temperature being too high during the self-discharge of the battery, and increasing the efficiency of the self-discharge of the battery.

FIG. 2 is a schematic diagram of a structure of the battery discharge control system according to an embodiment of the present disclosure. In the battery discharge control system of the present disclosure, the battery discharge control method described above may be implemented. When the battery self-discharges, the discharge speed of the battery may be controlled based on the temperature of the battery. As shown in FIG. 2, the battery discharge control system may include a temperature sensing unit 1 and a control unit 2. The control unit 2 and the temperature sensing unit 1 may be electrically connected. The temperature sensing unit 1 may be configured to detect the temperature of the battery 3. The control unit 2 may be connected with a discharge loop of the battery 3, and may be configured to adjust the discharge speed for the self-discharge of the battery based on the temperature of the battery 3 detected by the temperature sending unit 1.

Specifically, when the battery 3 self-discharges, typically it needs to be electrically connected with electric components such as the discharge load to form a discharge loop for discharging. The battery 3 may consume its charge through the voltage and current applied to the discharge loop. Because when the battery 3 self-discharges, heat accumulation may occur due to the discharge speed being too fast, causing the battery 3 to have a relative high temperature increase. If the temperature of the battery 3 is too high, battery leak or other safety risk may be caused. To detect the temperature of the battery 3 in real time, the battery discharge control system may include a temperature sensing unit 1. The temperature sensing unit 1 may be a contacting or non-contacting type temperature sensor, for example, a heat-sensitive component such as a heat-sensitive resistor, a temperature difference electric coupler, etc., or a sensing component that can detect heat radiation and temperature such as an infrared temperature sensing probe, etc. To maintain the accuracy of temperature detection, the temperature sensor typically needs to be disposed adjacent the battery 3, or be in contact with the electric core of the battery 3, to obtain the actual temperature of the battery.

After obtaining the temperature of the battery 3, the control unit 2 may determine whether there is a need to adjust the discharge speed of the battery 3 based on the temperature of the battery 3, to ensure the safety and to achieve a predetermined discharge performance. Typically, when the discharge speed of the battery 3 is relatively fast, the temperature of the battery 3 may increase; when the discharge speed of the battery 3 is relatively slow, the battery 3 may maintain a suitable temperature through normal heat dissipation. Therefore, when the temperature sensing unit 1 detects that the temperature of the battery 3 is relatively high, the discharge speed of the battery 3 may be decreased to reduce the temperature of the battery 3; when the detected temperature of the battery 3 is relatively low, the discharge speed may be increased to ensure the discharge efficiency of the battery 3.

Specifically, when the battery 3 self-discharges using the discharge loop, the discharge loop of the battery 3 typically includes the battery 3 and the discharge load 4 serially connected between the positive terminal of the battery 3 and the negative terminal of the battery 3. Because the discharge load 4 is typically a resistive load, hence only the discharge current flowing through the discharge load 4 may need be changed, in order to adjust the power consumption of the discharge load 4, thereby adjusting the discharge speed for the self-discharge of the battery 3. In addition, the power of consumption of the discharge load 4 may be controlled to adjust the discharge speed of the battery 3, which is not limited by the present disclosure.

In some embodiments, when adjusting the discharge speed of the battery 3 by changing the discharge current flowing through the discharge load 4, the control unit 2 may include a current control circuit. An input end of the current control circuit may be connected with the temperature sensing unit 1. An output end of the current control circuit may be connected with the discharge loop of the battery 3, and be configured to control the current flowing through the discharge load 4 based on the current flowing through the temperature sensing unit 1.

As an optional embodiment, the current control circuit may include a transistor 21. The base terminal b of the transistor 21 may be connected with the temperature sensing unit 1. A collector terminal c of the transistor 21 may be serially connected with a first end of the discharge load 4. A second end of the discharge load 4 may be connected with the positive terminal of the battery 3. The negative terminal of the battery 3 may be connected with the emitter terminal e of the transistor 21. Because a predetermined amplification ratio exists between the amplitudes of the currents at the base terminal b and the collector terminal c of the transistor 21, when the amplitude of the current at one end changes, the amplitude of the current at the other end may be caused to change. At this moment, an association may be established between the current in the temperature sensing unit 1 and the discharge current in the discharge circuit of the battery 3 based on the predetermined ratio relationship between the base terminal b and the collector terminal c of the transistor 21, such that when the current in the temperature sensing unit 1 changes under the effect of the change in the temperature of the battery 3, the amplitude of the discharge current in the discharge circuit may also be affected.

Because when the temperature sensing unit 1 detects the temperature, the detection current generated therein is typically relatively small. Therefore, by connecting the temperature sensing unit 1 with the base terminal b of the transistor 21, and connecting the discharge load 4 with the collector terminal c of the transistor 21, control of the amplitude of a relatively large discharge current in the discharge loop may be realized through a relatively small change in the current of the temperature sensing unit 1.

In addition, the temperature sensing unit 1 may be various different types. For example, as a relatively simple realization structure, the temperature sensing unit 1 may include a heat-sensitive resistor. The heat-sensitive resistor and the battery may have heat conduction, and the heat-sensitive resistor may be connected with the base terminal b of the transistor 21. Because when the heat-sensitive resistor is heated, its resistance value may change, which may affect the amplitude of the current input to the base terminal b of the transistor 21. The amplitude of the discharge current in the discharge circuit located at the side of the connector terminal c may be controlled based on the predetermined ratio relationship between the currents of the base terminal b and the collector terminal c of the transistor 21.

To decrease the discharge speed of the battery 3 when the temperature of the battery 3 increases, and to maintain a relatively fast discharge speed of the battery 3 when the temperature of the battery 3 reduces, it may be desirable to make the amplitude of the current of the temperature sensing unit 1 to change inverse-proportionally with the increase and decrease of the temperature of the battery 3. Specifically, when the temperature sensing unit 1 includes a heat-sensitive resistor, the heat-sensitive resistor may be a positive temperature coefficient (“PTC”) heat-sensitive resistor. The resistance of the PTC heat-sensitive resistor may increase as the temperature increases, and decrease as the temperature decreases. As such, when the voltage at the input end of the current amplification circuit is constant, according to the inverse-proportional relationship between the resistance and the current, as the resistance of the PTC heat-sensitive resistor increases, the current at the base terminal b of the transistor 21 may reversely decreases, which causes the discharge current in the discharge loop to decrease. At this moment, the discharge speed of the battery 3 is decreased. When the temperature of the battery 3 decreases, the resistance of the PTC heat-sensitive resistor decreases accordingly. At this moment, the currents at the base terminal b and the collector terminal c of the transistor both increase, causing the discharge speed of the battery 3 to increase, and thereby ensuring the discharge efficiency of the self-discharge of the battery 3.

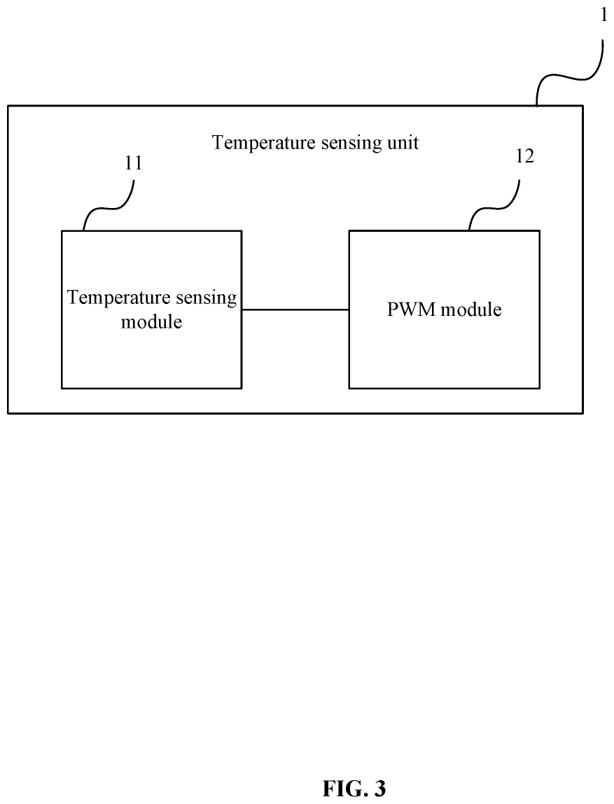

FIG. 3 is a schematic diagram of a structure of a temperature sensing unit of the battery discharge control system according to an embodiment of the present disclosure. As shown in FIG. 2 and FIG. 3, as another form of the temperature sensing unit 1, the temperature sensing unit 1 may include a temperature sensing module 11 and a PWM module 12 electrically connected with the temperature sensing module 11 and configured to perform pulse width modulation. The temperature sensing module 11 may be configured to detect a temperature of the battery. The output end of the PWM module 12 may be connected with the base terminal b of the transistor 21. The PWM module 12 may be configured to transmit a current signal whose duty cycle changes with the temperature of the battery.

Because the current signal transmitted by the PWM module 12 is not a continuous current, but exists in the form of a pulse wave or pulse, the duty cycle of the pulse wave may be controlled by controlling the number of pulse waves in the same period or the continuous time of the pulse wave, to output effective currents of different amplitudes. Specifically, when the PWM module 12 transmits a pulse wave, a bias of the base terminal of the transistor or the gate terminal of the MOS to realize a change in the connected time in the transistor or the MOS. Even when the currents flowing through have the same amplitudes, because the length of the connected time has changed, the amplitude of the effective current may change accordingly.

At this moment, when the temperature of the battery detected by the temperature sensing module 11 is different, the PWM module 12 may control the change in the connected time of the circuit by outputting different pulse waves having different duty cycles, to thereby outputting effective current signals having different amplitudes. If the duty cycle of the current signal is relatively large, it may indicate that the number of pulse waves in the same period is relatively large, and the effective current is relatively large. When the duty cycle of the current signal is relatively small, it may indicate that the number of pulse waves in the same period is relatively small, therefore, the effective current is relatively small. As such, through the adjustment of the PWM module 12, effective currents of different amplitudes may be output, which may be synchronously amplified by the transistor 21 in the current amplification circuit, and used for controlling the discharge speed of self-discharge of the battery 3.

Because the temperature sensing unit 1 and the control unit 2 may adjust the discharge speed of the battery 3 based on the temperature change of the battery 3 and through changing the amplitude of the discharge current flowing through the discharge load 4 or changing the power-on time of the discharge current, the degree of fast or slow of the self-discharge of the battery 3 may be controlled based on the temperature of the battery 3, avoiding to cause any safety risk due to the temperature being too high caused by the discharge speed being too fast. In the meantime, it can be ensured as much as possible that the battery 3 has a relatively high self-discharge speed and self-discharge efficiency.

In some embodiments, the battery discharge control system may include a temperature sensing unit and a control unit. The control unit and the temperature sensing unit may be electrically connected. The temperature sensing unit may be configured to detect a temperature of the battery. The control unit may be connected with the discharge loop of the battery, and be configured to adjust the discharge speed for the self-discharge of the battery based on the temperature of the battery detected by the temperature sensing unit. As such, the discharge speed at which the battery self-discharges may be adjusted based on the temperature of the battery, avoiding causing any safety risk due to the temperature of the battery being too high during self-discharge, and enabling the battery to have a relatively high self-discharge efficiency.

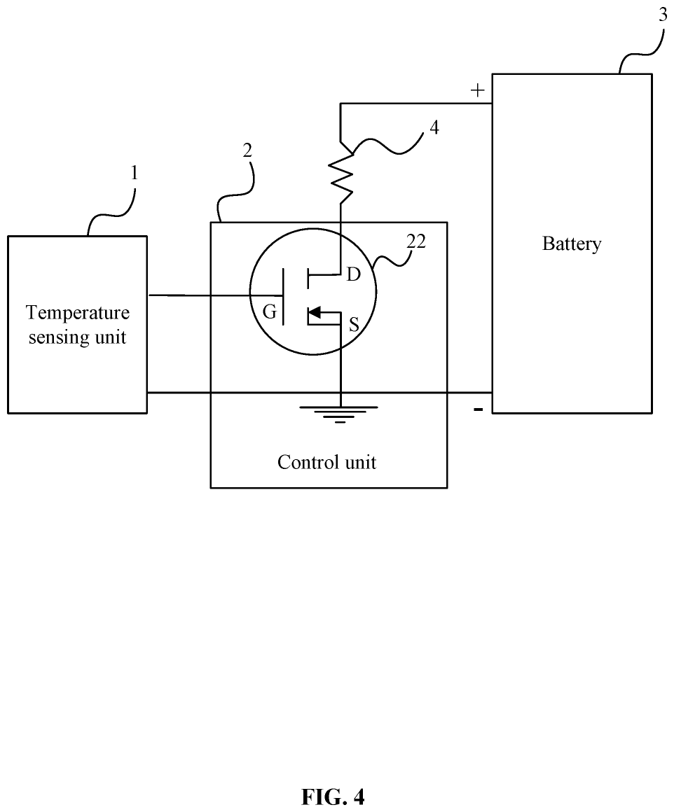

In addition, the current control circuit configured to control the discharge speed for the self-discharge of the battery may use other structures and fashions. FIG. 4 is a schematic diagram of a structure of another battery discharge control system according to an embodiment of the present disclosure. As shown in FIG. 4, the overall structure of the battery discharge control system is similar to that of the battery discharge control system described above. The difference may include, in the battery discharge control system of the present embodiment, the current control circuit may include a MOS 22, where the gate terminal G of the MOS 22 may be connected with the temperature sensing unit 1. The drain terminal D of the MOS 22 may be connected with a first end of the discharge load 4. A second end of the discharge load 4 may be connected with a positive terminal of the battery 3. A negative terminal of the battery 3 may be connected with the source terminal S of the MOS 22.

Specifically, there may be a predetermined amplification ratio between the gate terminal G and the drain terminal D of the MOS 22. Thus, an association between the voltage or current of the temperature sensing unit 1 and the discharge current of the discharge circuit may be established based on the predetermined ratio relationship between the gate terminal G and the drain terminal D. MOS differs from the transistor in that the MOS does not need to be driven by a current during operation, as long as the voltage changes, the MOS can control the current change at the drain terminal and/or the source terminal. Therefore, no current needs to be ensured to be input at the input end of the current control circuit. As long as the temperature sensing unit 1 can provide a voltage to the gate terminal G, the amplitude of the discharge current in the discharge circuit may be controlled based on the change in the voltage, thereby realizing controlling the amplitude of the discharge current through the voltage.

Similarly, the temperature sensing unit 1 configured to detect the temperature of the battery may use other various different structures and fashions. For example, the temperature sensing unit 1 may include a heat-sensitive resistor. The heat-sensitive resistor may have heat conduction with the battery 3. The heat-sensitive resistor may be connected with the gate terminal G of the MOS 22. The detailed structure and the operation principle of the heat-sensitive resistor may be similar to those described above in the previous embodiment, which are not repeated.

Further, when the temperature sensing unit 1 includes a heat-sensitive resistor, the heat-sensitive resistor may be a positive temperature coefficient (“PTC”) heat-sensitive resistor. The resistance of the PTC heat-sensitive resistor may increase as the temperature increases, and decreases as the temperature decreases. As such, by setting a voltage-division resistor, when the resistance of the PTC heat-sensitive resistor increases, the voltage at the gate terminal G of the MOS 22 may reversely decrease, which causes the discharge current in the discharge loop to decrease. At this moment, the discharge speed of the battery 3 may be decreased. When the temperature of the battery 3 decreases, the resistance of the PTC heat-sensitive resistor decreases accordingly. At this moment, by setting the voltage-division resistor, the voltage at the gate terminal G of the MOS 22 may reversely increase, and the current in the discharge loop located at the drain terminal D of the MOS 22 may increase, causing the discharge speed of the battery 3 to increase, thereby ensuring the discharge efficiency of the self-discharge of the battery 3.

Correspondingly, when the current amplification circuit includes MOS 22, the temperature sensing unit 1 may include other fashions and structures. For example, the structure of the temperature sensing unit 1 may be similar to that shown in FIG. 4, i.e., may include the temperature sensing module 11 and the PWM module 12 electrically connected with the temperature sensing module 11. The temperature sensing module 11 may be configured to detect the temperature of the battery 3. The output end of the PWM module 12 may be connected with the gate terminal of the MOS 22. The PWM module 12 may be configured to transmit a voltage signal whose duty of cycle may change with the temperature of the battery 3. The PWM module 12 may control the amplitude of the voltage at the gate terminal G of the MOS 22 by controlling the duty cycle of the pulse wave. After being synchronously amplified by the current amplification circuit, the amplitude of the current in the discharge circuit may be adjusted, thereby changing the discharge speed of the battery 3. The operation method of the PWM module 12 and the control principle of the PWM module 12 for controlling the amplitude of the voltage may be similar to those described above in the previous embodiments, which are not repeated.

In the present embodiment, the battery discharge control system may include a temperature sensing unit and a control unit. The control unit and the temperature sensing unit may be electrically connected. The temperature sensing unit may be configured to detect the temperature of the battery. The control unit may be connected with the discharge loop of the battery, and may be configured adjust the discharge speed for the self-discharge of the battery based on the temperature detected by the temperature sensing unit. The current control circuit may include the MOS. The gate terminal of the MOS may be connected with the temperature sensing unit. The drain gate of the MOS may be connected with a first end of the discharge load. A second end of the discharge load may be connected with a positive terminal of the battery. A negative terminal of the battery may be connected with the source terminal of the MOS. As such, by controlling the amplitude of the discharge current through connecting or disconnecting the voltage, the discharge speed for the self-discharge of the battery may be adjusted based on the temperature of the battery, thereby avoiding any safety risk caused by the temperature of the battery at self-discharge being too high, and enabling the discharge efficiency of the battery to be relatively high.

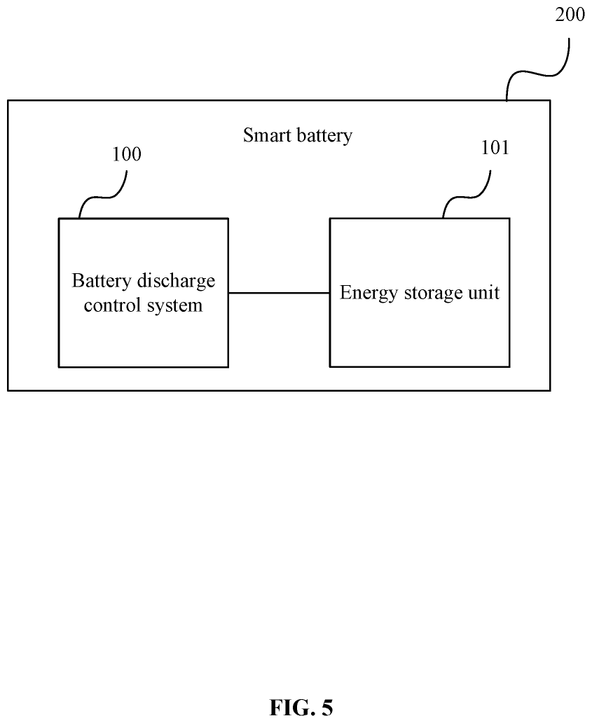

FIG. 5 is a schematic diagram of a structure of a smart battery according to an embodiment of the present disclosure. As shown in FIG. 5, a smart battery 200 of the present embodiment may include one or multiple energy storage units 101 configured to store electric energy and a battery discharge control system 100. The battery discharge control system 100 may be electrically connected with the energy storage units 101, and may be configured to control the discharge speed of the energy storage units 101. The battery discharge control system 100 may execute any of the battery discharge control method disclosed herein, and may control the discharge speed of the energy storage units 101 based on the temperature of the energy storage units 101 included in the smart battery 200. The detailed structure, components, functions, and operation principles of the battery discharge control system 100 have been described in detail in connection with the above embodiments, which are not repeated.

Specifically, the smart battery 200 may include one or multiple energy storage units 101. The energy storage unit 101 may typically be an electric core or other structure configured to store electric energy. When there are multiple energy storage units 101, the multiple energy storage units may be assembled through a stacking fashion and may be connected together. The battery discharge control system 100 may detect the temperature of the energy storage units 101, and may control the discharge speed of the energy storage units 101 based on the detected temperature, avoiding the temperature of the energy storage units 101 being too high or too low, thereby effectively avoiding any safety risk of the smart battery 200 caused by too much heat accumulation in the energy storage units 101.

A person having ordinary skills in the art can appreciate, a battery itself is an energy storage unit. Thus, it should be noted that the energy storage unit in the present embodiment and the battery described above in the previous embodiments generally have the same definition and scope. The smart battery of the present embodiment may include both a storage battery and a battery discharge control system, thereby forming a storage system having a certain degree of intelligence and automatic control capability.

In the present embodiment, the smart battery may include one or multiple energy storage units configured to store electric energy and a battery discharge control system. The battery discharge control system may be electrically connected with the energy storage units and may be configured to control the discharge speed of the energy storage units. The battery discharge control system may include a temperature sensing unit and a control unit. The control unit may be electrically connected with the temperature sensing unit, and may be configured to adjust the discharge speed for self-discharge of the battery based on the temperature of the battery detected by the temperature sensing unit. As such, the discharge speed for the self-discharge of the smart battery may be adjusted based on the temperature of the energy storage units in the smart battery, avoiding any safety risk caused by the temperature of the energy storage units of the smart battery being too high during self-discharge, and enabling the smart battery to have a relatively high self-discharge efficiency.

A person having ordinary skills in the art can appreciate: some or all of the steps of the embodiments of the above-described methods may be accomplished by program codes instructing related hardware. The program may be stored in a computer-readable storage medium. When the program is executed, the steps of the methods of the above embodiments may be executed. The storage medium may include various types of media that can store program codes, such as: a read only memory (“ROM”), a random access memory (“RAM”), a magnetic disk, or an optical disk.

Finally, it is understood that the above embodiments are only used to explain the technical solutions of the present disclosure, and are not used to limit the scope of the present disclosure. Although the technical solutions are described in detail with reference to various embodiments, a person having ordinary skills in the art can appreciate: the technical solutions described in the various embodiments may be modified, or some or all of the technical features may be equivalently substituted. Such modification or substitution does not separate the principles of the corresponding technical solutions from the scope of the various embodiments of the present disclosure.

What is claimed is:

1. A battery discharge control method, comprising:
detecting a temperature of a battery when the battery self-discharges; and
adjusting a discharge speed for the self-discharge of the battery based on the temperature of the battery.

2. The battery discharge control method of claim 1, wherein adjusting the discharge speed for the self-discharging of the battery based on the temperature of the battery comprises:
adjusting the discharge speed for the self-discharge of the battery based on a relationship between the temperature of the battery and a predetermined temperature.

3. The battery discharge control method of claim 2, wherein adjusting the discharge speed for the self-discharge of the battery based on the relationship between the temperature of the battery and the predetermined temperature comprises:
decreasing the discharge speed when the temperature of the battery is greater than or equal to the predetermined temperature; or
increasing the discharge speed when the temperature of the battery is smaller than the predetermined temperature.

4. The battery discharge control method of claim 1, wherein adjusting the discharge speed for the self-discharge of the battery comprises:
changing an amplitude of a discharge current flowing through a discharge load or changing a power-on time of the discharge current, wherein the discharge load and the battery are electrically connected to form a loop.

5. The battery discharge control method of claim 4, wherein changing the amplitude of the discharge current flowing through the discharge load or changing the power-on time of the discharge current comprises:
changing the power-on time of the discharge current through a pulse width modulation.

6. The battery discharge control method of claim 4, wherein changing the amplitude of the discharge current flowing through the discharge load or changing the power-on time of the discharge current comprises:
changing the amplitude of the discharge current that is an output current of an amplification circuit by adjusting an amplitude of an input current of the amplification circuit,
wherein an input end of the amplification circuit is a control end, and
wherein the loop formed by the discharge load and the battery is located at an output end of the amplification circuit.

7. The battery discharge control method of claim 6, wherein the amplification circuit is a transistor amplification circuit,
wherein changing the amplitude of the discharge current that is the output current of the amplification circuit by adjusting the amplitude of the input current of the amplification circuit comprises:
changing the amplitude of the discharge current that is a current at a collector terminal by adjusting an amplitude of a current at a base terminal.

8. The battery discharge control method of claim 6, wherein the amplification circuit is a metal-oxide-semiconductor field-effect transistor (“MOS”) amplification circuit,
wherein changing the amplitude of the discharge current that is the output current of the amplification circuit by adjusting the amplitude of the input current of the amplification circuit comprises:
changing the amplitude of the discharge current at a drain terminal of the MOS by adjusting an amplitude of a voltage at a gate terminal of the MOS.

9. The battery discharge control method of claim 3, wherein the predetermined temperature is a safe operation temperature of the battery.

10. The battery discharge control method of claim 9, wherein the predetermined temperature of the battery is 35° C. to 60° C.

11. The battery discharge control method of claim 1, wherein adjusting the discharge speed for the self-discharge of the battery comprises:
adjusting the discharge speed by adjusting a discharge parameter of a discharge load.

12. The battery discharge control method of claim 11, wherein the discharge parameter of the discharge load comprises at least one of: a discharge time, a discharge frequency, a configuration of a discharge circuit, or a resistance of a discharge resistor.

13. A smart battery, comprising:
one or multiple energy storage units configured to store electric energy; and
a battery discharge control system electrically connected with the one or multiple energy storage units and configured to control a discharge speed of the one or multiple energy storage units,
wherein the battery discharge control system comprises:
a temperature sensing unit configured to detect a temperature of the one or multiple energy storage units; and
a control unit electrically connected with the temperature sensing unit, wherein the control unit is also configured to electrically connect with a discharge loop of the one or multiple energy storage units, and is further configured to adjust the discharge speed for a self-discharge of the one or multiple energy storage units based on the temperature of the one or multiple energy storage units detected by the temperature sensing unit,
wherein the discharge loop of the one or multiple energy storage units comprises the smart battery and a discharge load serially connected between a positive terminal of the one or multiple energy storage units and a negative terminal of the one or multiple energy storage units.

14. The smart battery of claim 13, wherein the control unit comprises a current control circuit, an input end of the current control circuit is connected with the temperature sensing unit, an output end of the current control circuit is connected with the discharge loop of the one or multiple energy storage units, wherein the current control circuit is configured to control a current flowing through the discharge load based on a current flowing through the temperature sensing unit.
